(19) United States
(12) Patent Application Publication
(10) Pub. No.: US 2023/0036076 A1
(43) Pub. Date: Feb. 2, 2023

(54) MULTI-LAYER BIOBASED FILM STRUCTURES USING POLY(3-HYDROXYPROPIONATE)

(71) Applicant: Meredian, Inc., Bainbridge, GA (US)

(72) Inventors: Michael Mang, Bainbridge, GA (US); Phillip Van Trump, Decatur, GA (US)

(73) Assignee: Meredian, Inc., Bainbridge, GA (US)

(21) Appl. No.: 17/877,291

(22) Filed: Jul. 29, 2022

Related U.S. Application Data
(60) Provisional application No. 63/227,010, filed on Jul. 29, 2021.
(60) Provisional application No. 63/226,807, filed on Jul. 29, 2021.
(60) Provisional application No. 63/226,874, filed on Jul. 29, 2021.

(51) Int. Cl. B32B 27/36; B32B 27/08

(52) U.S. Cl. CPC B32B 27/36; B32B 27/08; B32B 2439/70; B32B 2307/7163; B32B 2307/4023; B32B 2307/7244

(57) ABSTRACT

A multi-layer packaging film structure is disclosed. This packaging film structure includes a barrier web made up of a barrier web core layer, a barrier web skin layer, and a packaging sealant layer. Each of the aforementioned film layers is biodegradable and/or compostable. At least one of the film layers is made up of at least 1 weight percent of poly(3-hydroxypropionate). The packaging film structure may also include a print web or a paperboard substrate.

### CROSS-REFERENCE TO RELATED APPLICATIONS

This application claims the benefit of the earlier filing date of provisional applications 63/226,807, 63/226,874, and 63/227,010, each filed Jul. 29, 2021, the disclosures of which are each incorporated by reference in its entirety.

### FIELD

This disclosure relates to biodegradable polymeric compositions. More particularly, this disclosure relates to a multi-layer film structure, for food packaging or other applications, which is biodegradable and/or compostable and more specifically home compostable.

### BACKGROUND

Snack food, as well as many other consumer goods, are typically packaged in sealed disposable bags. Other food or consumer items may be packaged using paperboard substrates which are coated with a polymeric film structure. Conventionally these bags and other packaging materials are made from film structures made up of multiple layers of polymer films which are adhered or laminated together to provide a packaging having a desired combination of strength properties, barrier properties (with respect to moisture, oxygen, grease, and so forth) and good printability for product packaging graphics.

In the past, most or all of these film layers have been composed primarily of petroleum-based polymers such as polyethylene (PE), polypropylene (PP), or polyethylene terephthalate (PET). While these polymers may provide good strength, barrier, and/or printability characteristics for the film structure, such polymers do not readily degrade or decompose after disposal—either in landfills or by home composting techniques. Thus, film structures and bags made from such polymers may subsist in landfills for centuries after disposal.

It would be desirable to provide a multi-layer film structure suitable the packaging of foods and other consumer items, which are biodegradable and/or compostable. In particular, it would be desirable to provide a multi-layer film structure suitable for product or food packaging which is predominantly home compostable. Most preferably, the film structure would be completely home compostable.

### SUMMARY OF THE INVENTION

The above and other needs are met by a multi-layer packaging film structure according to the present disclosure. According to one embodiment, this film structure includes a barrier web. This barrier web in turn includes a barrier web core layer having a first side and a second side, a barrier web skin layer adhered or laminated to the first side of the web core layer, and a packaging sealant layer adhered or laminated to the second side of the web core layer. According to the present disclosure, the barrier web core layer, the barrier web skin layer, and the packaging sealant layer are each biodegradable and/or compostable. Moreover, at least one of the barrier web core layer, the barrier web skin layer, and the packaging sealant layer is made up of at least 1 weight percent of poly(3-hydroxypropionate).

More preferably, at least one of the barrier web core layer, the barrier web skin layer, and the packaging sealant layer is made up of at least 20 weight percent of poly(3-hydroxypropionate). In some instances, at least one of the layers may be made up at least 50 weight percent, at least 70 weight percent, or at least 80 weight percent of poly(3-hydroxypropionate).

In some instances, the barrier web core layer is made up of poly(3-hydroxypropionate). In certain embodiments, the barrier web core layer may include at least one additional biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

According to certain embodiments, the barrier web skin layer is made up of poly(3-hydroxypropionate). Moreover, in some embodiments, the barrier web skin layer may also include at least one additional biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

In accordance with some embodiments, the packaging sealant layer is made up of poly(3-hydroxypropionate). Further in some instances, the packaging sealant layer may also include at least one additional biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

In addition to the poly(3-hydroxypropionate), and optionally other biodegradable polymers, various other additives may also be included in the layers.

In certain embodiments, at least one of the barrier web core layer, the barrier web skin layer, and the packaging sealant layer also includes a nucleating agent selected from the group consisting of erythritols, pentaerythritol, dipentaerythritols, artificial sweeteners, stearates, polysaccharides, sorbitols, mannitols, inositols, polyester waxes, nanoclays, behenamide, erucamide, stearamide, oleamide, polyhydroxybutyrate, thymine, cyanuric acid, cytosine, adenine, uracil, guanine, boron nitride, and mixtures thereof.

In some instances, at least one of the barrier web core layer, the barrier web skin layer, and the packaging sealant layer, also includes a filler selected from group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, chitin, and mixtures thereof.

In accordance with certain embodiments, at least one of the barrier web core layer, the barrier web skin layer, and the packaging sealant layer may also include a plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, poly(ethylene) glycols having a number average molecular weight of 400-10,000 g/mol, esters of vegetable oils, long chain alkyl acids, adipates, glycerol, isosorbide derivatives or mixtures thereof, HALLGREEN IM-8830 ester, HALLGREEN R-8010 ester, polyhydroxyalkanoate copolymers comprising at least 18 mole percent monomer residues of hydroxyalkanoates other than hydroxybutyrate, and mixtures thereof.

In some embodiments, at least one of the barrier web core layer, the barrier web skin layer, the packaging sealant layer, and the print web may also include a chain extender selected from the group consisting of organic peroxy acids, inorganic peroxy acids, epoxy functionalized reagents, or mixtures thereof.

According to certain embodiments, the core layer may be made up of a plurality of sub-layers. The core layer may include a first, a second, and a third sub-layer, with the second sub-layer is disposed between the first and the second sub-layers. In such embodiments, the second sub-layer is preferably made up of at least 80 weight percent poly(3-hydroxypropionate).

In certain embodiments, the film structure, in addition to the barrier web, may also include a print web having a first side and a second side and ink printed onto at least one of the print web first and second side. The barrier web skin layer is adhered or laminated to the print web by an adhesive layer or an extruded lamination layer disposed between the barrier web skin layer and print web. In such embodiments, the print web is biodegradable and/or compostable and is preferably made up of at least 1 weight percent of poly(3-hydroxypropionate).

In some instances, this print web may also include at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

In other embodiments, the film structure, in addition to the barrier web, may also include a paperboard substrate having a first side and a second side, wherein the barrier web skin layer is adhered or laminated to the paperboard substrate by an adhesive layer or an extruded lamination layer disposed between the barrier web skin layer and the paperboard substrate.

In some embodiments of the film structure, the barrier web core layer, the barrier web skin layer, and the packaging sealant layer are each home compostable, as determined in accordance with ASTM D6400.

In accordance with certain embodiments of the film structure, the barrier web exhibits a Water Vapor Permeation which is less than about 16.5 gram-mil/m²/day, as determined in accordance with ASTM F1927, at 38° C. and 90% RH.

Moreover, in some instances, the barrier web exhibits an Oxygen Permeation which is less than about 3.5 gram-mil/m²/day, as determined in accordance with ASTM D3985, at 23° C. and 0% RH.

In certain embodiments, the barrier web has a heat seal temperature from about 85° C. to about 115° C. The barrier web also has a seal strength which is at least about 230 grams per centimeter, as determined in accordance with ASTM F2029 and F88. Preferably, the barrier web has a seal strength which is from about 235 to about 990 grams per centimeter, as determined in accordance with ASTM F2029 and F88.

### DETAILED DESCRIPTION

The present disclosure provides a multi-layer packaging film structure. This multi-layer film structure includes at least a barrier web. In various embodiments, film structure may also include a print web or a paperboard substrate. For example, the barrier web skin layer may be adhered or laminated to the print web by an adhesive layer or an extruded laminated layer disposed between the barrier web skin layer and print web.

Preferably, both the barrier web and the print web (if present) are biodegradable and/or compostable. More particularly each individual layer of the multi-layer film structure is biodegradable and/or compostable.

As used herein, the term “biodegradable” refers to a plastic or polymeric material that will undergo biodegradation by living organisms (microbes) in anaerobic and aerobic environments (as determined by ASTM D5511), in soil environments (as determined by ASTM 5988), in freshwater environments (as determined by ASTM D5271 (EN 29408)), or in marine environments (as determined by ASTM D6691). The biodegradability of biodegradable plastics can also be determined using ASTM D6868 and European EN 13432.

The polymeric or plastic material of the present disclosure is preferably also “compostable”, as determined by ASTM D6400 for industrial or home compostability.

The barrier web is made up of at least 3 film layers. Specifically, the barrier web includes at least a barrier web core layer having a first side and a second side, a barrier web skin layer adhered or laminated to the first side of the web core layer, and a packaging sealant layer adhered or laminated to the second side of the web core layer.

The composition of each individual layer of the barrier web may vary somewhat, as described below. Importantly, however, each individual layer of the barrier web is preferably biodegradable and/or home compostable.

A significant aspect of the present disclosure is the use of poly(3-hydroxypropionate) in the film structure. According to the present disclosure, at least one of the barrier web core layer, the barrier web skin layer, the packaging sealant layer, and the print web is made up of at least 1 weight percent of poly(3-hydroxypropionate). In some embodiments, at least one of the barrier web core layer, the barrier web skin layer, the packaging sealant layer, and the print web is more preferably made up of at least 20 weight percent of poly(3-hydroxypropionate). In some instances, at least one of the layers may be made up at least 50 weight percent, at least 70 weight percent, or at least 80 weight percent of poly(3-hydroxypropionate).

In some instances, only a single layer of the multi-layer packaging film structure may include poly(3-hydroxypropionate). In other embodiments, multiple layers, or even all the layers, of the film structure may include poly(3-hydroxypropionate) in the amounts noted above.

Moreover, each of the layers of the multi-layer packaging film structure may also include one or more additional biodegradable polymers, besides the poly(3-hydroxypropionate). For instance, in certain embodiments, at least one of the barrier web core layer, the barrier web skin layer, the packaging sealant layer, and the print web may also include at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, cellulose acetate, and mixtures thereof.

For embodiments in which one or more layers includes a polyhydroxyalkanoate other than poly(3-hydroxypropionate, the polyhydroxyalkanoate may in some instances be a homopolymer, made up only a single type of monomer residues. Generally, however, the polyhydroxyalkanoate polymer is a copolymer, made up of at least two different type of monomer residues. In some instances, the polyhydroxyalkanoate polymer may be a terpolymer, made up of at least three different type of monomer residues.

For instance, in some embodiments, the polyhydroxyalkanoate polymer is preferably a copolymer made up of from about 75 to about 99.9 mole percent monomer residues of 3-hydroxybutyrate and from about 0.1 to about 25 mole percent monomer residues of a second 3-hydroxyalkanoate having from 5 to 12 carbon atoms.

In other embodiments, the polyhydroxyalkanoate polymer is preferably a terpolymer made up from about 75 to about 99.9 mole percent monomer residues of 3-hydroxybutyrate and from about 0.1 to about 25 mole percent monomer residues of 3-hydroxyhexanoate, and from about 0.1 to about 25 mole percent monomer residues of a third 3-hydroxyalkanoate having from 5 to 12 carbon atoms.

Each of the individual film layers may also include various other additives in addition to the poly(3-hydroxypropionate) and the other aforementioned biopolymers.

For instance, in accordance with some embodiments, at least one of the barrier web core layer, the barrier web skin layer, the packaging sealant layer, and the print web also includes a nucleating agent selected from the group consisting of erythritols, pentaerythritol, dipentaerythritols, artificial sweeteners, stearates, sorbitols, mannitols, inositols, polyester waxes, nanoclays, behenamide, erucamide, stearamide, oleamide, polyhydroxybutyrate, thymine, cyanuric acid, cytosine, adenine, uracil, guanine and boron nitride, and mixtures thereof.

In some embodiments, at least one of the barrier web core layer, the barrier web skin layer, the packaging sealant layer, and the print web also includes a filler selected from group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, chitin, and mixtures thereof.

In some instances, at least one of the barrier web core layer, the barrier web skin layer, the packaging sealant layer, and the print web also includes a plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, poly(ethylene) glycols having a number average molecular weight of 400-10,000 g/mol, esters of vegetable oils, long chain alkyl acids, adipates, glycerol, isosorbide derivatives or mixtures thereof, HALLGREEN IM-8830 ester, HALLGREEN R-8010 ester, polyhydroxyalkanoate copolymers comprising at least 18 mole percent monomer residues of hydroxyalkanoates other than hydroxybutyrate, and mixtures thereof.

Also, according to certain embodiments, at least one of the barrier web core layer, the barrier web skin layer, the packaging sealant layer, and the print web also includes a chain extender selected from the group consisting of organic peroxy acids, inorganic peroxy acids, epoxy functionalized reagents, or mixtures thereof.

The individual layers of the barrier web may be joined together either by lamination or by the use of an adhesive. As used herein, an adhesive includes an aqueous and/or organic solvent which substantially evaporates over time, as well as tackifiers and other components. After the adhesive dries, only the non-solvent portions are left and serve to bind together the individual layers of the barrier web. By contrast, in lamination, an extruded polymer film, having little or no solvent, is disposed between two layers of the web to bind the layers together.

In some embodiments, the core layer of the barrier web may actually be made up of a plurality of sub-layers. For instance, the core layer may include a first sub-layer, a second sub-layer, and a third sub-layer, with the second sub-layer is disposed between the first and the second sub-layers. In such embodiments, the second sub-layer is preferably made up of at least 80 weight percent poly(3-hydroxypropionate). Optionally, the first and/or the second sub-layer may also include poly(3-hydroxypropionate).

As noted above, in certain embodiments, the film structure also includes a print web. Like the barrier web, the print web is also preferably biodegradable and/or home compostable and is preferably made up of at least 1 weight percent of poly(3-hydroxypropionate).

The print web has a first side and a second side and desired packaging graphics may be printed on either side of the print web. Thus, the print web may be printed on the its outer side or it may be reverse printed on its inner side.

The barrier web skin layer is adhered or laminated to the print web by an adhesive layer or an extruded lamination layer disposed between the barrier web skin layer and print web.

Suitable adhesives may be either aqueous and/or organic solvent-based adhesives. Suitable lamination materials may be blends (including reactive blends) of biodegradable polymers, such as polyhydroxyalkanoates, polybutylene succinate, polybutylene succinate co butylene adipate, polybutylene adipate co butylene terephthalate, polycaprolactone, polylactic acid, cellulose acetate, and mixtures thereof Preferred biodegradable polymers for the extruded lamination include polycaprolactone and polybutylene adipate terephthalate (PBAT). In the lamination process, a polymeric resin is melted in an extruder and passes through a die that is sandwiched between the print web and the barrier web in order to bind the two webs together.

In other embodiments, the film structure may include a paperboard substrate in addition to the barrier web. This paperboard substrate includes a first side and a second side. The barrier web skin layer is generally adhered or laminated to the paperboard substrate by an adhesive layer or an extruded lamination layer disposed between the barrier web skin layer and the paperboard substrate.

The multi-layer food packaging film structure according to the present disclosure may be used for food packaging for the packaging of other consumer items. Thus, according to one embodiment, a portion of the film structure is formed and cut to provide a blank for a generally rectangular pouch or bag. A first set of generally parallel edges of the blank are overlapped and sealed to along a seam to form a tube-like sleeve. A food product may be inserted into this sleeve and the ends of the sleeve are then sealed to provide a final packaged food product. According to certain embodiments, this process may be automated by use of a vertical or horizontal form, fill, and seal (“FFS”) packaging machine.

Food products which may be packaged according to the present disclosure include snack chips, such as potato chips, corn chips, pretzels, confections, and the like.

For packaging application such as the aforementioned, the film structures according to the present disclosure have been found to provide excellent barrier properties, particularly with respect to water vapor and oxygen transmission.

For instance, in accordance with certain embodiments of the film structure, the barrier web exhibits a Water Vapor Permeation which is less than about 16.5 gram-mil/m²/day, as determined in accordance with ASTM F1927, at 38° C. and 90% RH.

With regard to oxygen, the barrier web exhibits an Oxygen Permeation which is less than about 3.5 gram-mil/m²/day, as determined in accordance with ASTM D3985, at 23° C. and 0% RH.

At the same time, the barrier web also exhibits good heat seal properties. Typically, the barrier web has a heat seal temperature from about 85° C. to about 115° C. The barrier web also has a seal strength which is at least about 230 grams per centimeter, as determined in accordance with ASTM F2029 and F88. Preferably, the barrier web has a seal strength which is from about 235 to about 990 grams per centimeter, as determined in accordance with ASTM F2029 and F88.

The present disclosure is also further illustrated by the following embodiments:

Embodiment 1. A multi-layer packaging film structure comprising:

a barrier web comprising a barrier web core layer having a first side and a second side, a barrier web skin layer adhered or laminated to the first side of the web core layer, and a packaging sealant layer adhered or laminated to the second side of the web core layer,

wherein the barrier web core layer, the barrier web skin layer, and the packaging sealant layer are each biodegradable and/or compostable, and

wherein at least one of the barrier web core layer, the barrier web skin layer, and the packaging sealant layer comprises at least 1 weight percent of poly(3-hydroxypropionate).

Embodiment 2. The multi-layer packaging film structure of Embodiment 1, wherein at least one of the barrier web core layer, the barrier web skin layer, and the packaging sealant layer at least 20 weight percent of poly(3-hydroxypropionate).

Embodiment 3. The multi-layer packaging film structure of Embodiment 1 or 2, wherein the barrier web core layer comprises poly(3-hydroxypropionate).

Embodiment 4. The multi-layer packaging film structure of Embodiment 3, wherein the barrier web core layer further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

Embodiment 5. The multi-layer packaging film structure of any of the preceding Embodiments, wherein the barrier web skin layer comprises poly(3-hydroxypropionate).

Embodiment 6. The multi-layer packaging film structure of Embodiment 5, wherein the barrier web skin layer further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

Embodiment 7. The multi-layer packaging film structure of any of the preceding Embodiments, wherein the packaging sealant layer comprises poly(3-hydroxypropionate).

Embodiment 8. The multi-layer packaging film structure of Embodiment 7, wherein the packaging sealant layer further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

Embodiment 9. The multi-layer packaging film structure of any of the preceding Embodiments, wherein at least one of the barrier web core layer, the barrier web skin layer, and the packaging sealant layer further comprises a nucleating agent selected from the group consisting of erythritols, pentaerythritol, dipentaerythritols, artificial sweeteners, stearates, polysaccharides, sorbitols, mannitols, inositols, polyester waxes, nanoclays, behenamide, erucamide, stearamide, oleamide, polyhydroxybutyrate, thymine, cyanuric acid, cytosine, adenine, uracil, guanine, boron nitride, and mixtures thereof.

Embodiment 10. The multi-layer packaging film structure of any of the preceding Embodiments, wherein at least one of the barrier web core layer, the barrier web skin layer, and the packaging sealant layer, further comprises a filler selected from group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, chitin, and mixtures thereof.

Embodiment 11. The multi-layer packaging film structure of any of the preceding Embodiments, wherein at least one of the barrier web core layer, the barrier web skin layer, and the packaging sealant layer comprises a plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, poly(ethylene) glycols having a number average molecular weight of 400-10,000 g/mol, esters of vegetable oils, long chain alkyl acids, adipates, glycerol, isosorbide derivatives or mixtures thereof, HALLGREEN IM-8830 ester, HALLGREEN R-8010 ester, polyhydroxyalkanoate copolymers comprising at least 18 mole percent monomer residues of hydroxyalkanoates other than hydroxybutyrate, and mixtures thereof.

Embodiment 12. The multi-layer packaging film structure of any of the preceding Embodiments, wherein at least one of the barrier web core layer, the barrier web skin layer, the packaging sealant layer, and the print web further comprises a chain extender selected from the group consisting of organic peroxy acids, inorganic peroxy acids, epoxy functionalized reagents, or mixtures thereof.

Embodiment 13. The multi-layer packaging film structure of any of the preceding Embodiments, wherein the core layer comprises a first, a second, and a third sub-layer, wherein the second sub-layer is disposed between the first and the second sub-layers and wherein the second sub-layer comprises at least 80 weight percent poly(3-hydroxypropionate).

Embodiment 14. The multi-layer packaging film structure of any of the preceding Embodiments, further comprising a print web having a first side and a second side and ink printed onto at least one of the print web first and second side,

wherein the barrier web skin layer is adhered or laminated to the print web by an adhesive layer or an extruded lamination layer disposed between the barrier web skin layer and print web, and

wherein the print web is biodegradable and/or compostable and comprises at least 1 weight percent of poly(3-hydroxypropionate).

Embodiment 15. The multi-layer packaging film structure of Embodiment 14, wherein the print web further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

Embodiment 16. The multi-layer packaging film structure of any of the preceding Embodiments, further comprising a paperboard substrate having a first side and a second side, wherein the barrier web skin layer is adhered or laminated to the paperboard substrate by an adhesive layer or an extruded lamination layer disposed between the barrier web skin layer and the paperboard substrate.

Embodiment 17. The multi-layer packaging film structure of any of the preceding Embodiments, wherein the barrier web core layer, the barrier web skin layer, and the packaging sealant layer are each home compostable, as determined in accordance with ASTM D6400.

Embodiment 18. The multi-layer packaging film structure of any of the preceding Embodiments, wherein the barrier web exhibits a Water Vapor Permeation which is less than about 16.5 gram-mil/m²/day, as determined in accordance with ASTM F1927, at 38° C. and 90% RH.

Embodiment 19. The multi-layer packaging film structure of any of the preceding Embodiments, wherein the barrier web exhibits an Oxygen Permeation which is less than about 3.5 gram-mil/m²/day, as determined in accordance with ASTM D3985, at 23° C. and 0% RH.

Embodiment 20. The multi-layer packaging film structure of any of the preceding Embodiments, wherein the barrier web has a seal strength which is at least about 230 grams per centimeter, as determined in accordance with ASTM F2029 and F88.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A multi-layer packaging film structure comprising:
a barrier web comprising a barrier web core layer having a first side and a second side, a barrier web skin layer adhered or laminated to the first side of the web core layer, and a packaging sealant layer adhered or laminated to the second side of the web core layer,
wherein the barrier web core layer, the barrier web skin layer, and the packaging sealant layer are each biodegradable and/or compostable, and
wherein at least one of the barrier web core layer, the barrier web skin layer, and the packaging sealant layer comprises at least 1 weight percent of poly(3-hydroxypropionate).

2. The multi-layer packaging film structure of claim 1, wherein at least one of the barrier web core layer, the barrier web skin layer, and the packaging sealant layer at least 20 weight percent of poly(3-hydroxypropionate).

3. The multi-layer packaging film structure of claim 1, wherein the barrier web core layer comprises poly(3-hydroxypropionate).

4. The multi-layer packaging film structure of claim 3, wherein the barrier web core layer further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

5. The multi-layer packaging film structure of claim 1, wherein the barrier web skin layer comprises poly(3-hydroxypropionate).

6. The multi-layer packaging film structure of claim 5, wherein the barrier web skin layer further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

7. The multi-layer packaging film structure of claim 1, wherein the packaging sealant layer comprises poly(3-hydroxypropionate).

8. The multi-layer packaging film structure of claim 7, wherein the packaging sealant layer further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

9. The multi-layer packaging film structure of claim 1, wherein at least one of the barrier web core layer, the barrier web skin layer, and the packaging sealant layer further comprises a nucleating agent selected from the group consisting of erythritols, pentaerythritol, dipentaerythritols, artificial sweeteners, stearates, polysaccharides, sorbitols, mannitols, inositols, polyester waxes, nanoclays, behenamide, erucamide, stearamide, oleamide, polyhydroxybutyrate, thymine, cyanuric acid, cytosine, adenine, uracil, guanine, boron nitride, and mixtures thereof.

10. The multi-layer packaging film structure of claim 1, wherein at least one of the barrier web core layer, the barrier web skin layer, and the packaging sealant layer, further comprises a filler selected from group consisting of calcium carbonate, talc, nano clays, nanocellulose, hemp fibers, kaolin, carbon black, wollastonite, glass fibers, carbon fibers, graphite fibers, mica, silica, dolomite, barium sulfate, magnetite, halloysite, zinc oxide, titanium dioxide, montmorillonite, feldspar, asbestos, boron, steel, carbon nanotubes, cellulose fibers, flax, cotton, starch, polysaccharides, aluminum hydroxide, magnesium hydroxide, chitin, and mixtures thereof.

11. The multi-layer packaging film structure of claim 1, wherein at least one of the barrier web core layer, the barrier web skin layer, and the packaging sealant layer comprises a plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, poly(ethylene) glycols having a number average molecular weight of 400-10,000 g/mol, esters of vegetable oils, long chain alkyl acids, adipates, glycerol, isosorbide derivatives or mixtures thereof, HALLGREEN IM-8830 ester, HALLGREEN R-8010 ester, polyhydroxyalkanoate copolymers comprising at least 18 mole percent monomer residues of hydroxyalkanoates other than hydroxybutyrate, and mixtures thereof.

12. The multi-layer packaging film structure of claim 1, wherein at least one of the barrier web core layer, the barrier web skin layer, the packaging sealant layer, and the print web further comprises a chain extender selected from the group consisting of organic peroxy acids, inorganic peroxy acids, epoxy functionalized reagents, or mixtures thereof.

13. The multi-layer packaging film structure of claim 1, wherein the core layer comprises a first, a second, and a third sub-layer, wherein the second sub-layer is disposed between the first and the second sub-layers and wherein the second sub-layer comprises at least 80 weight percent poly(3-hydroxypropionate).

14. The multi-layer packaging film structure of claim 1, further comprising a print web having a first side and a second side and ink printed onto at least one of the print web first and second side,
wherein the barrier web skin layer is adhered or laminated to the print web by an adhesive layer or an extruded lamination layer disposed between the barrier web skin layer and print web, and
wherein the print web is biodegradable and/or compostable and comprises at least 1 weight percent of poly(3-hydroxypropionate).

15. The multi-layer packaging film structure of claim 14, wherein the print web further comprises at least one biodegradable polymer selected from the group consisting of polyhydroxyalkanoates other than poly(3-hydroxypropionate), polybutylene succinate, polybutylene succinate co butylene adipate, polybutylene adipate co butylene terephthalate, polycaprolactone, polylactic acid, poly(vinyl alcohol), polyglycolic acid, polyglycolic acid/polylactic acid copolymer, cellulose acetate, and mixtures thereof.

16. The multi-layer packaging film structure of claim 1, further comprising a paperboard substrate having a first side and a second side, wherein the barrier web skin layer is adhered or laminated to the paperboard substrate by an adhesive layer or an extruded lamination layer disposed between the barrier web skin layer and the paperboard substrate.

17. The multi-layer packaging film structure of claim 1, wherein the barrier web core layer, the barrier web skin layer, and the packaging sealant layer are each home compostable, as determined in accordance with ASTM D6400.

18. The multi-layer packaging film structure of claim 1, wherein the barrier web exhibits a Water Vapor Permeation which is less than about 16.5 gram-mil/m²/day, as determined in accordance with ASTM F1927, at 38° C. and 90% RH.

19. The multi-layer packaging film structure of claim 1, wherein the barrier web exhibits an Oxygen Permeation which is less than about 3.5 gram-mil/m²/day, as determined in accordance with ASTM D3985, at 23° C. and 0% RH.

20. The multi-layer packaging film structure of claim 1, wherein the barrier web has a seal strength which is at least about 230 grams per centimeter, as determined in accordance with ASTM F2029 and F88.
